(19) United States
(12) Patent Application Publication
(10) Pub. No.: US 2002/0157764 A1
(43) Pub. Date: Oct. 31, 2002

(54) Method for making a sound reducing panel with resistive layer having structural property and resulting panel

(76) Inventors: Robert Andre, La Croix-Falgarde (FR); Alain Porte, Colomiers (FR); Herve Batard, Tournefeuille (FR)

Correspondence Address: YOUNG & THOMPSON, 745 SOUTH 23RD STREET 2ND FLOOR, ARLINGTON, VA, 22202

(21) Appl. No.: 09/914,181

(22) PCT Filed: Dec. 21, 2000
(86) PCT No.: PCT/FR00/03648

(30) Foreign Application Priority Data
Dec. 24, 1999 (FR) 99/16447

(51) Int. Cl. B65C 3/26

(52) U.S. Cl. 156/156; 156/176; 156/252

(57) ABSTRACT

A process for the production of an acoustical attenuating panel comprises emplacing on a mold a layer (1′a) with structural properties constituted by filaments (7, 8) pre-impregnated with a thermoplastic or thermosetting resin, by draping, winding or wrapping, such that the layer has an open surface quantity of about 30% of the total surface of the exposed layer, emplacing from above the layer with structural properties a layer (1′b) with acoustical properties constituted by a microporous cloth of a thickness of about one tenth of that of the layer with structural properties, then emplacing a cellular structure (2) and a reflector (3) with if desired the addition of an adhesive (5, 6) between the components, at least one step of baking in an autoclave being practiced at the end of at least one of the above-mentioned emplacing steps.

The present invention relates to an acoustically attenuating panel more particularly adapted to absorb at least partially sonic energy of the flow of a gas at high speed.

The invention will be described in its application to the production of panels for the attenuation of noise arising particularly from aircraft turbo motors, in certain positions on the nacelle, for example at the inlet and outlet of the fan passage, but of course the invention is adapted to applications in any other environment where it seems necessary or desirable to use a structure of the panel type combining lightness, high mechanical resistance and acoustic properties.

The panel according to the invention is of the well-known type constituted by a sandwich comprising a cellular structure of the beehive type bounded, on the air flow side, with an acoustically resistive layer and, on the opposite side, with a rear reflector. The cellular structure can be single, which is to say a single resonator or a single layer cellular core, or else multiple, which is to say superposed resonators or with a cellular core formed by several superposed layers separated or not by septa.

The acoustically resistive layer plays a dissipating role. When the sound wave passes through it, it produces viscous effects which partially transform the acoustic energy into heat. The cellular structure which is behind the resistive layer traps this sound wave thanks to the cells which behave as wave guides perpendicular to the surface of said layer, the wave being reflected by the rear reflector of the panel.

To obtain good acoustic attenuation, it is necessary to combine a certain number of conditions of which the principal ones are a good matching of the height of the cells of the cellular structure to the frequencies of the sound wave which it is desired to handle and the adaptation of the impedance of the resistive layers (septum and front surface) such that they produce a maximum dissipation at the frequencies of interest.

Moreover, it is thus essential to have an optimum acoustic homogeneity both at the level of the resistive layers and at that of the cellular structure.

Moreover, such a panel must, because of its environment, resist severe conditions of use. In particular, it must not run the risk of delamination of the resistive layer even in the presence of strong underpressure and must be resistant to erosion or abrasion as well as to corrosion, have a good electrical conductivity, and be adapted to absorb the energy of a mechanical impact.

Such a panel must also of course have sufficient structural properties particularly to receive and transfer the aerodynamic forces, inertial forces and those connected with he maintenance of the nacelle, toward the nacelle/motor structural connections.

The surface condition of the resistive layer finally must satisfy the aerodynamic requirements of the environment.

Known acoustical attenuation panels, particularly those used in the nacelles of turbo motors, meet the set of above requirements more or less satisfactorily.

Among these panels, all built on the same principle of a resonant structure comprising a front resistive layer and a cellular structure closed by a rear reflector, can be cited those using a so-called non-linear processing with a single degree of freedom and shown for example in European patent EP 0 038 746, in the name of the applicant.

Such a panel comprises a honeycomb bounded, on one side, by an acoustically resistive layer constituted by a rigid and thin woven member of composite material and, on the other side, a reflector.

Such a structure has the advantage of good control of he percentage of open space of the resistive layer because said woven material is formed of orthogonal meshes of for example carbon fibers delimiting between them openings whose size can be regulated during the impregnation process of the fibers with a thermosetting resin, then hardening the resin, the woven material being subjected to shaping under pressure and temperature so as to obtain said rigid and thin woven material.

The resistive layer thus obtained moreover has a good structural strength and finally has the advantage of being a single layer component.

However, its drawbacks are also substantial. This resistive layer has a high acoustical non-linearity which causes its surface impedance to vary in a significant way with the noise level.

Moreover, for this type of layer, the grazing flow produces a phenomenon of constriction of the sections for the passage of air in the holes. The acoustical resistance of this layer will also depend on the speed of this grazing flow.

Moreover, the resistive layer provides a frequency window of restricted efficacy, as well as a low resistance to erosion.

According to another so-called linear processing mode, also with a single decree of freedom, shown for example in GB 2 130 963, the resistive layer is formed of two components, namely, a structural layer, on the side of the honeycomb, and a layer with a microporous surface.

A structural layer is formed of a cloth of carbon fibers with relatively large meshes defining an opening quantity of about 30% of the total surface of the layer.

The microporous surface layer is a cloth of fine mesh of mineral or synthetic fibers or a metallic cloth, serving as an acoustical dampener.

The advantages of such a structure are the possibility of adjustment of the acoustic resistance of the resistive layer acting on the two components of this latter, the reduction of the acoustic non-linearity given rise to less dependence of the acoustic resistance on the acoustic level and on the speed of tangential flow at the surface of the resistive layer. Moreover, there is obtained a frequency window of effectiveness that is wider in comparison to the preceding technical solution.

On the other hand, such a structure has the principal drawback of a supplemental assembly, which is costly in time and money, because of the bi-component character of the resistive layer. If the constraints involved in the assembly of this structure are not well controlled, there is the risk of acoustic inhomogeneity, as well as delamination of the resistive layer.

Finally, there also exists a risk of corrosion of the exposed microporous layer, giving rise to difficulties at the level of the choice of materials.

According to a third processing technique, so-called with two degrees of freedom, the panel comprises a layer resistive at its surface, two superposed honeycombs separated by a resistive layer, called a septum, generally microporous, and a reflector.

The advantages of this structure are that there is obtained a frequency window of effectiveness that is very great, the possibility of adjustment of the acoustical resistance by acting on the two resistive layers, the low or moderate acoustic non-linearity.

On the other hand, the emplacement of two superposed cellular structures separated by a resistive layer, renders the process of production longer and more costly and introduces risks of acoustic inhomogeneity, arising from possible misalignment of the honeycombs, cumulative to the effects of the gluing, as well as of transverse sonic propagation in thee misaligned regions.

Finally, in EP 0 911 803 there is disclosed an acoustic attenuation panel formed by a sandwich comprising a cellular structure bordered, on one side, by a reflector, and on the other side by a metallic cloth which is itself covered by a perforated metallic sheet.

Such an arrangement permits obtaining panels whose surface exposed to aerodynamic flow and which is defined by the combination of metallic fabric and perforated metallic sheet, has good acoustic properties at the same time as good structural properties.

However, such panels can have drawbacks particularly when they have a sharp curvature, which is the case particularly in inlet and outlet panels of the tan passage.

Thus, according to EP 0 911 803, the metallic sheet is first prepared and then pierced before being emplaced and shaped on the assembly, comprising moreover the cellular structure, the reflector and the metallic fabric.

Because of the fact that the shape of the panel is not a figure of revolution and at can have convexities or concavities that can be sharp, the shaping of the pre-perforated sheet gives rise to local deformation of portions of the sheet and hence of the holes located in these portions. These deformations are adapted substantially to modify the area of the holes and hence the amount of local porosity of the perforated sheet, thereby giving rise to an inhomogeneity of the porosity of the sheet, prejudicial to its effectiveness in terms of acoustic attenuation.

Moreover, such a shaping is difficult, because the sheet is relatively rigid.

Finally, generally speaking, panels of the all-metallic type, which is the case of the above panel, are by nature adapted to give rise to problems of corrosion.

The invention seeks to overcome the various drawbacks of these known techniques, by providing a mode of fabrication of an acoustic attenuation panel of the type with a cellular structure bordered on the one side by a reflector and on the other side by an acoustical layer resistive to two respective components, namely, acoustic property and structural property, permitting obtaining panels with a complex shape particularly with developing curvatures that can be great and particularly monobloc panels of a generally annular shape with or without a rib, such as those destined for the inlet and outlet of the fan passage of nacelles, having both very good mechanical properties and optimum acoustical properties.

To this end, the invention has for its object a process for the production or an acoustical attenuating panel comprising a cellular structure bordered on the one side by a reflector and on the other side by an acoustically resistive layer with two components respectively with acoustical property and with structural property, characterized in that it consists:

in emplacing on a mold of a shape appropriate to the panel to be obtained, a layer with a structural property constituted by filaments pre-impregnated with a thermoplastic or thermosetting resin, by draping, winding or wrapping, such that said layer has a proportion of open surface of the order of 30% of the total surface of the exposed surface,

covering the layer with structural property, with a layer of acoustical property constituted by a microporous cloth of a thickness of a tenth of that of the layer with structural property,

then emplacing the cellular structure and the reflector with if desired the addition of an adhesive between the components,

at least one step of baking in an autoclave being used at the end of at least one of the above steps of emplacement.

The process of the invention permits obtaining a resistive acoustical layer with remarkable acoustical and structural properties, in particular the effectiveness of acoustic attenuation because of the very high homogeneity of the quantity of porosity of said resistive acoustical layer, which can be precisely defined.

Thus, the fact of using pre-impregnated filaments shaped on a mold not only permits producing complex shapes that can have sharp curves, but above all permits very good control of the porosity of the layer with structural properties.

According to an embodiment of the method, there is given to said layer with structural properties the required porosity by the choice and spacing of the woven filaments, in this case a cloth, the flexibility of this last permitting matching the shapes of the mold without substantial deformation of the meshes of the cloth.

In the case of wound or wrapped filaments, the adjustment of the spacing of the filaments permits adjusting precisely the degree of porosity.

According to another embodiment of the process, there is given to this layer with structural properties the requisite porosity by piercing said layer after baking in an autoclave.

The piercing taking place with precise diameters and in a shaped and rigid member, the control of the porosity is perfectly ensured.

Preferably, and according to another embodiment of the process and for reinforcing purposes, the layer with structural properties constituted by several layers of ross filaments, the layers being on opposite sides of the layer with acoustical properties.

The invention also has for its object the panels obtained according to the above process.

Other characteristics and advantages will become apparent from the description which follows, of different embodiments of the process of the invention, which description is given solely by way of example and with respect to the accompanying drawings, in which:

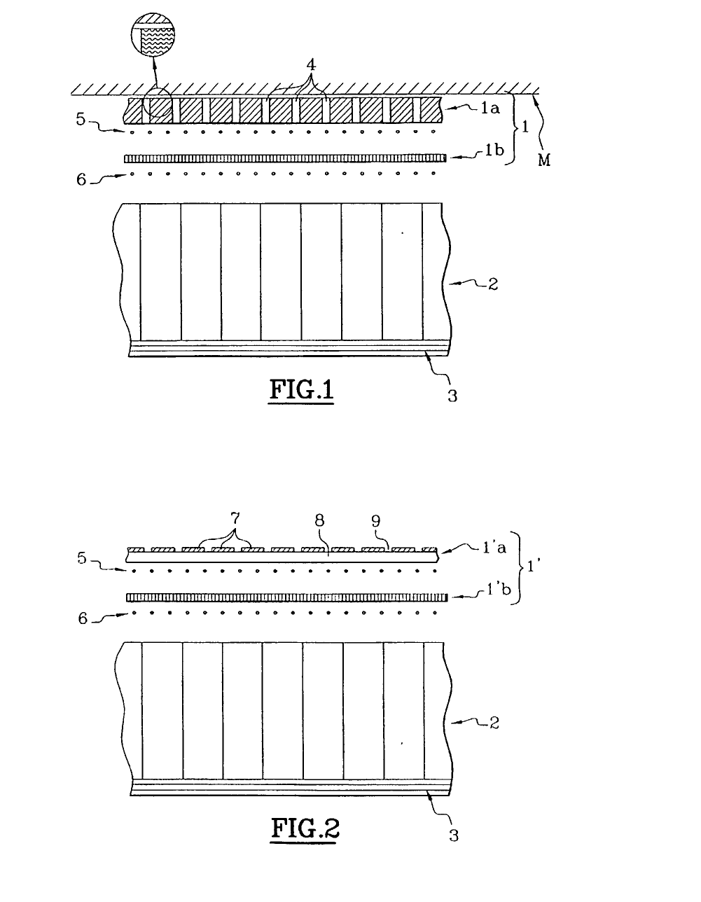

FIG. 1 is a cross-sectional exploded schematic view of a panel structure obtained according to the process of the invention;

FIG. 2 is a similar cross-sectional view illustrating another embodiment of the process of the invention;

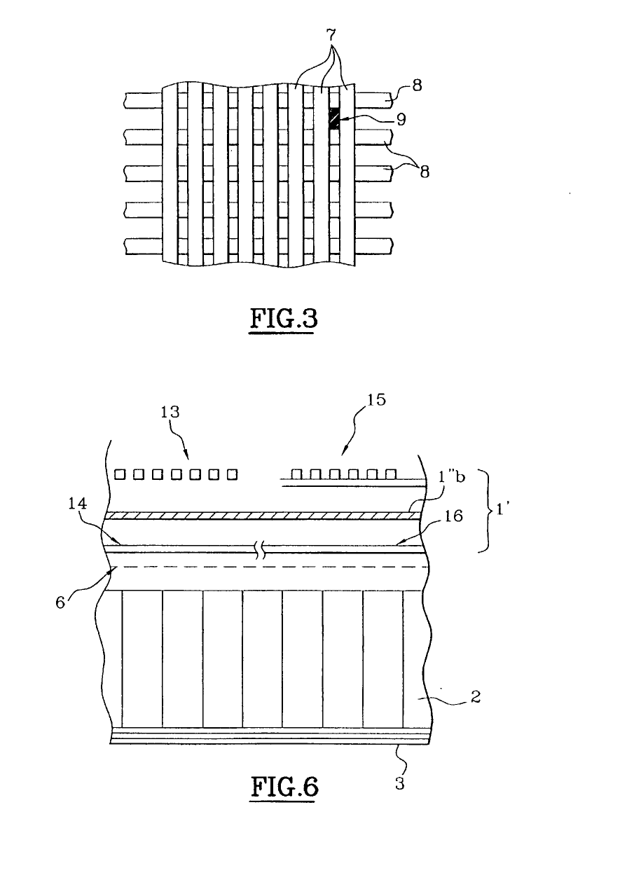

FIG. 3 is a fragmentary top plan view of the layer with structural property, of the panel of FIG. 2;

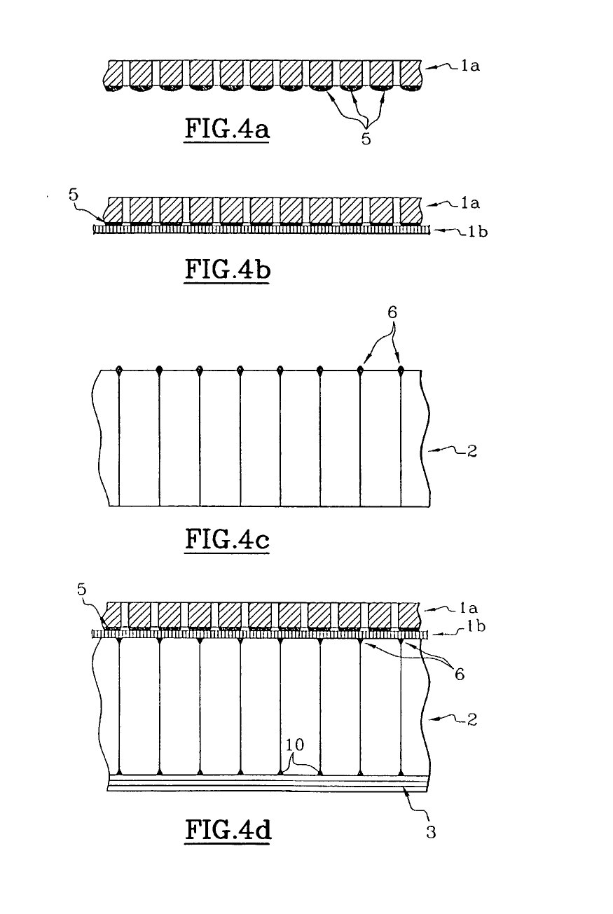

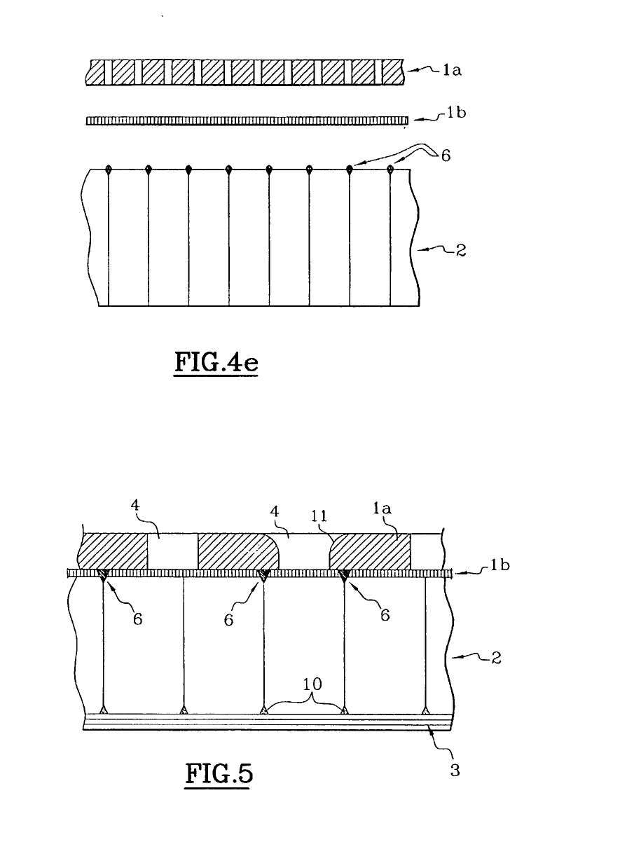

FIGS. 4a to 4e show different steps in the production of a panel of the type of FIG. 1,

FIG. 5 is a fragmentary cross-sectional view showing a manner of gluing by the bi-component acoustical layer onto the cellular structure, and

FIG. 6 is a fragmentary cross-sectional view showing a modification of the process shown in FIG. 2.

More precisely, the panel is of a single piece, annular, without a rib or with a single rib, and is made with a mold shown at M in FIG. 1, with shapes and dimensions suitable to those of the panel to be obtained and on which will be draped, wound or wrapped the successive layers of the panel.

The first of these layers is a layer 1a with structural properties, on which will then be emplaced a layer 1b with acoustical properties, the assembly 1a-1b forming the two components of a so-called acoustically resistive layer 1, on which will be emplaced a cellular structure 2, single as shown or multiple as described above.

Finally, from above the cellular structure 2 is emplaced a conventional reflector 3.

According to the invention, the layer 1a with structural properties is formed from filaments pre-impregnated with a suitable thermoplastic or thermosetting resin. By filaments, there are intended filaments, fibers, roving in the form of a ribbon of square or rectangular cross-section, of carbon, glass, “Kevlar”, or other mineral or organic fibers, natural or synthetic.

The layer 1b with acoustical properties is formed by a very thin cloth of carbon, glass, “Kevlar” or other mineral or organic fibers, natural or synthetic, dried or pre-impregnated.

The cellular structure 2 is for example a paper of aramid fibers such as that commercially sold as “NOMEX”.

In the embodiment of the method shown in FIG. 1, the layer with structural properties constituted by a cloth draped on the mold M, or by filaments deposited by winding or wrapping, is carried out, then polymerized by baking in an autoclave.

There is thus obtained a composite sheet, rigid, smooth and shaped, which is then pierced according to the desired quantity of open surface.

This quantity of open surface is preferably of the order of 30% of the exposed surface of the layer 1a.

The perforations 4 provided for this purpose in the layer 1a preferably have a ratio of the diameter of the thickness of the layer 1a greater than 1, to reduce the undesirable effects of acoustical non-linearity.

The perforations 4 are made by various mechanical means, for example laser or electro-erosion.

After perforation of the holes 4, the layer 1a being still in place on the mold M, the layer 1b with acoustical properties is emplaced, with if desired the interposition of an adhesive layer 5, then the cellular structure 2 is emplaced with if desired the interposition of a second adhesive layer 6 and finally the reflector 3.

A second polymerization by baking in an autoclave can be carried out after emplacement of the layers 1b and 5, then a third polymerization by baking in an autoclave is carried out after emplacement of the layers 2 and 3, a cross-linking adhesive being preferably interposed between the layers 2 and 3. Finally, the mold M is opened to take out the finished panel.

The choice of adhesives 5, 6 and their manner of application, as well as the choice of the cloth of the layer 1b and of the ways of polymerization, are determined so as to obtain a quantity of open surface after cementing in the layer 1b, corresponding to the desired quantity, which is to say giving to the resistive layer 1 the required factor of non-linearity.

The embodiment of FIG. 2 is similar to that of FIG. 1, except that the layer 1′a with structural properties of the resistive bi-component acoustical layer 1′, is constituted by roving of fibers disposed in the weft direction or the cloth, namely of the roving of warp 7 and the roving of weft 8, the mesh thus produced defining passage openings 9 (FIG. 3) that are rectangular or square, constituting about 30% of the surface of the layer 1′a.

The fibers of the roving 7, 8 can be of the type indicated above, dried or pre-impregnated. The roving 7, 8 is disposed unitarily by winding, wrapping or manual deposition or not, on a mold (not shown) analogous to the mold M of FIG. 1. The polymerization is then carried out.

The spacing between rovings 7, 8 and the conditions of polymerization are defined so as to give to the layer 1′a the desired factor of non-linearity.

In the example shown in FIGS. 1 and 2, the thickness of the layer 1a, 1′a with structural properties is of the order of 10 times the thickness of the layer 1b, 1′b with acoustical properties.

It is to be noted that the layer 1a with structural properties can be constituted by several folds of cloth of pre-impregnated fibers or of several superposed layers of pre-impregnated fibers wound or wrapped.

The acoustically resistive layers (1, 1′) of the panels according to the invention, although constituted by two components, nevertheless have excellent mechanical qualities.

Thus, materials of the two components, structural and acoustical, are identical and compatible and lead to good gluing and constitute after polymerization a single composite sheet with almost no danger of delamination, very resistant to erosion, to abrasion, to shocks and moreover easy to repair.

Furthermore, the resistive layers have, because of the precise control of their amount of porosity during production, a very good acoustical performance particularly in terms of non-linearity, their impedance not depending on the Mach number of the grazing flow.

The panels according to the invention are also simple and easy to make.

FIGS. 4a to 4d show an embodiment of the panel of the type of FIG. 1, on a mold (not shown) analogous to the mold M.

After construction and shaping of the structural component 1a, with the desired quantity of open surface, for example 30%, there is applied (FIG. 4a) the layer of cross-linking adhesive 5, then the acoustical layer 1b (FIG. 4b) is emplaced and polymerized with heat under pressure to assemble the two layers 1a, 1b.

Then the cross-linking adhesive 6 is emplaced (FIG. 4c) on the cellular structure 2.

Finally (FIG. 5d), all the elements of the panel are assembled during a new polymerization step under pressure with hear, an adhesive 10 being also emplaced on the other surface of the honeycomb in line with the base of the cells for gluing the rear reflective layer 3 which is itself single or multi-layered and whose structure is conventional.

Because of the high porosity of the acoustical layer 1b, there is obtained a fiery good adherence between the honeycomb 2 and the layer 1b.

Thus, the adhesive 6 diffuses well throughout the porous mass of the layer 1b and the junction between the end edge of the walls of the honeycomb cells 2 and the facing surface of the layer 1b is established by constituting good connecting bridges in line with the base of the cell of the honeycomb defining connections with a cross-section increasing in the direction of the surface of said layer 1b.

It is also to be noted that, generally speaking, the invention permits giving to the acoustical component (layer 1b) a very small thickness, much less than that of the structural layer 1a. By way of example, the layer 1a could have a thickness of one millimeter, whilst the thickness of the layer 1b could be reduced to 0.1. millimeter without loss of acoustical properties.

FIG. 4e shows a modified embodiment of the assembly of the layers 1a, 1b and 2, in which the cross-linking adhesive 5 between the layers 1a and 1b is omitted. Because, thus, of the small thickness and high porosity of the acoustical layer 1b, it is possible to apply the adhesive 6 only on the receiving surface of the honeycomb 2.

The adhesive 6, as shown in FIG. 5, migrates during polymerization throughout all the thickness of the porous layer 1b and comes into contact with the surface facing the external structural layer 1a. The assembly 1a, 1b, 2 is thus fixed securely.

In this assembly, the only adhesive (6) that is used is disposed solely in line with the basis of the honeycomb cells 2, which limits the obstruction of the passage openings 4 through the structural layer 1a to only the regions facing said cell basis.

The technique shown in FIGS. 4a to 4e is useful with various modifications of panel structure described above.

This technique permits easily designing and making panels for acoustical attenuation with good and homogeneous mechanical characteristics, adapted for various environments, particularly those mentioned above such as the nacelles of turbo motors.

In FIG. 5, there is also shown a modified embodiment of the notes 4 of the structural layer 1a during their perforation, according to which the external opening of said holes 4 is preferably beveled, by any suitable means, as shown at 11, so as to improve the acoustical linearity.

FIG. 6 shows another modified embodiment of the process of the invention according to which the layer with structural properties is reinforced. To this end, the layer with structural properties is constituted of several layers of crossed pre-impregnated filaments disposed on opposite sides of the layer 1″b with acoustical properties.

In the left portion of FIG. 6, there is shown a first distribution of two layers of crossing filaments, respectively a layer 13 of warp filaments, disposed first on a mold (not shown) analogous to the mold M of FIG. 1, and a layer 14 of weft filaments disposed from above the layer 1″b, which is to say after deposition of this latter.

In the right portion of FIG. 6, there is shown a second arrangement of three layers, namely two crossed layers according to a weft 15, disposed first on the mold and a third layer 16 of filaments parallel to the filaments of one of the layers of the weft 15, deposited from above the layer 1″b with acoustical properties.

The assembly of the components 13, 14, 15, 16, 1″b thus forms an acoustically resistive layer 1″ with properties both structural and acoustical.

This assembly is polymerized under pressure before emplacement of the other components 2, 3.

The spacing of the filaments of layers 13, 14, 15, 16 deposited by winding or wrapping determines the quantity of porosity of the layer 1″.

1. Process for the production of an acoustical attenuating panel comprising a cellular structure (2) covered on one side with a reflector (3) and on the other side with an acoustically resistive layer (1, 1′, 1″) with two components receptively with an acoustical property and with a structural property, characterized in that it consists:
in emplacing on a mold (M) of a shape appropriate to the panel to be obtained, a layer (1a, 1′a, 13, 15) with structural properties, constituted by filaments pre-impregnated with a thermoplastic or thermosetting resin, by draping, winding or wrapping, such that said layer has a quantity of open surface of the order of 30% of the total surface of the exposed layer,
in emplacing from above the layer with structural properties, a layer (1b, 1′b, 1″b) with acoustical properties, constituted by a microporous cloth of a thickness of the order of a tenth of that of the layer with structural properties,
then emplacing the cellular structure (2) and the reflector (3) with if desired the addition of an adhesive (5, 6, 10) between the components,
at least one step of baking in an autoclave being carried out at the end of at least one of the above steps of emplacement.

2. Process according to claim 1, characterized in that there is given to said layer (1′a) with structural properties the necessary porosity by the spacing of the filaments (7, 8) of the weaving or of the winding or of the wrapping of the filaments.

3. Process according to claim 1, characterized in that there is given to said layer (1a) with structural properties the necessary porosity by piercing said layer after baking in an autoclave, the layer (1b) with acoustical properties being thereafter emplaced.

4. Process according to claims 1 and 2, characterized in that the layers (1′a) with structural properties and (1′b) with acoustical properties are assembled with the possible interposition of a cross-linking adhesive (5) and subjected to baking in an autoclave, then the assembly is assembled with the structure (2) with a cellular core and with the reflector (3), with if desired the interposition of a cross-linking adhesive (6), and subjected to a new baking in an autoclave.

5. Process according to one of claims 1 to 4, characterized in that the layer with structural properties is constituted by several layers (13 to 16) of crossed filaments, the layers being on opposite sides of the layer (1′b) with acoustical properties.

6. Process according to claim 3, characterized in that the pierced holes (4) of the layer (1a) with structural properties have a diameter greater than the thickness of said layer and their external opening (11) is flared.

7. Panel made according to any one of claims 1 to 6.
